(19) United States
(12) Patent Application Publication
(10) Pub. No.: US 2009/0243509 A1
(43) Pub. Date: Oct. 1, 2009

(54) USER INTERFACE FOR WIRELESS LIGHTING CONTROL

(76) Inventors: Thomas Alan Barnett, Ypsilanti, MI (US); Jeffrey Iott, Monroe, MI (US); John Gerard Finch, Livonia, MI (US); Jian Xu, Windsor (CA); Ryan Scribner, Cambridge, MA (US)

Correspondence Address: Masco Corporation, 21001 Van Born Road, Taylor, MI, 48480, US

(21) Appl. No.: 12/398,566

(22) Filed: Mar. 5, 2009

Related U.S. Application Data
(60) Provisional application No. 61/033,838, filed on Mar. 5, 2008.

(51) Int. Cl. H05B 37/02

(52) U.S. Cl. 315/292; 315/297

(57) ABSTRACT

A system apparatus for controlling a lighting environment having one or more remote switches that control one or more lighting loads, has an active mode under which the system operates for a user, a linking mode to connect one or more switches to one or more lighting loads, an unlinking mode to disconnect one or more switches from the one or more lighting loads, one or more channels connecting one or more switches to one or more lighting loads, and a scene mode connecting one or more channels and dimming all the lighting loads to a desired dimness level in all connected channels to create a scene.

### REFERENCE TO RELATED APPLICATION

The application claims priority to U.S. Provisional Application No. 61/033,838 that was filed on Mar. 5, 2008.

### BACKGROUND OF THE INVENTION

This application relates to lighting control systems, and more particularly to a wireless lighting control system.

In a wireless lighting control system, such as a residential wireless lighting control system, there may be lighting loads connected to a receiver and controllable by a plurality of wireless switches. Linking the switches to lighting loads may be a complex task for an average consumer.

### SUMMARY OF THE INVENTION

A system apparatus for controlling a lighting environment having one or more remote switches that control one or more lighting loads, has an active mode under which the system operates for a user, a linking mode connecting one or more switches to one or more lighting loads, an unlinking mode disconnecting one or more switches from the one or more lighting loads, one or more channels connecting one or more switches to one or more lighting loads, and a scene mode connecting one or more channels and dimming all the lighting loads to a desired dimness level in all connected channels to create a scene.

If a user desires to program the switching system to meet his or her needs, an interface provides a relatively easy way to customize a lighting environment. The interface allows a user the flexibility to power any load or combination of loads with any switch or combination of switches, allows the user to dim any load or combination of loads to create specific effects (e.g., a scene) for those one or many loads, receives input as to the types of loads to be controlled to optimize control and help maximize the life of the loads, displays the degree of dimming for any load, and the number of switches attached to each load all while minimizing the effort a user exerts to program or change the programming. A user may also opt to program a few or several combinations of dimming, switches or loads simply.

These and other features of the present invention can be best understood from the following specification and drawings, the following of which is a brief description.

### BRIEF DESCRIPTION OF THE DRAWINGS

FIG. 1 schematically illustrates an example wireless switching application including a receiver.

FIG. 2 illustrates an example user interface of the receiver of FIG. 1.

FIG. 3a illustrates a channel display for the user interface of FIG. 2.

FIG. 3b illustrates the channel display of FIG. 2 wherein an incandescent load is shown.

FIG. 3c illustrates the channel display of FIG. 2 the wherein a fluorescent load is shown.

FIGS. 4A-4D schematically illustrate a switch linking process.

FIGS. 5A and 5B schematically illustrate a switch un-linking process.

FIGS. 6A-6D schematically illustrate a scene programming process.

FIGS. 7A-7C schematically illustrate a process for using dim buttons of the user interface of FIG. 2.

FIGS. 8A-8C schematically illustrate a process for using channel buttons of the user interface of FIG. 2.

FIG. 9 schematically illustrates a process for using scene buttons of the user interface of FIG. 2.

FIGS. 10A and 10B schematically illustrate a process for a single press of a wireless battery-less switch.

FIGS. 11A-11C schematically illustrate a process for a press and hold of a wireless battery-less switch.

FIGS. 12A-12B schematically illustrate a process for a double press of wireless battery-less switch.

FIG. 13 schematically illustrates a process for an escape button of the user interface of FIG. 2.

FIG. 14 schematically illustrates a process for maintaining the wireless switching application of the system.

### DETAILED DESCRIPTION OF THE PREFERRED EMBODIMENT

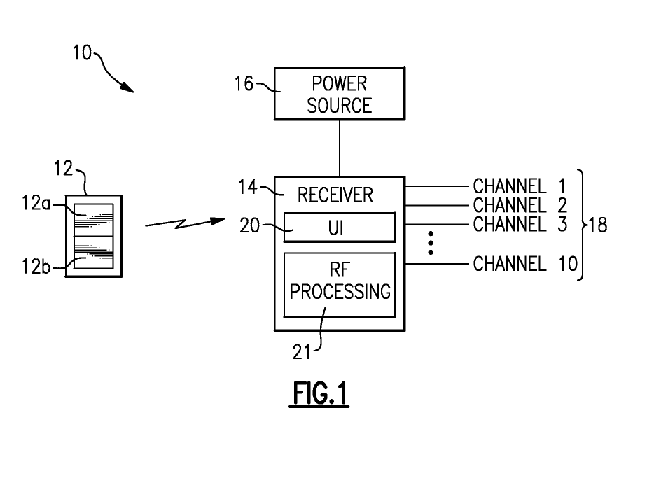

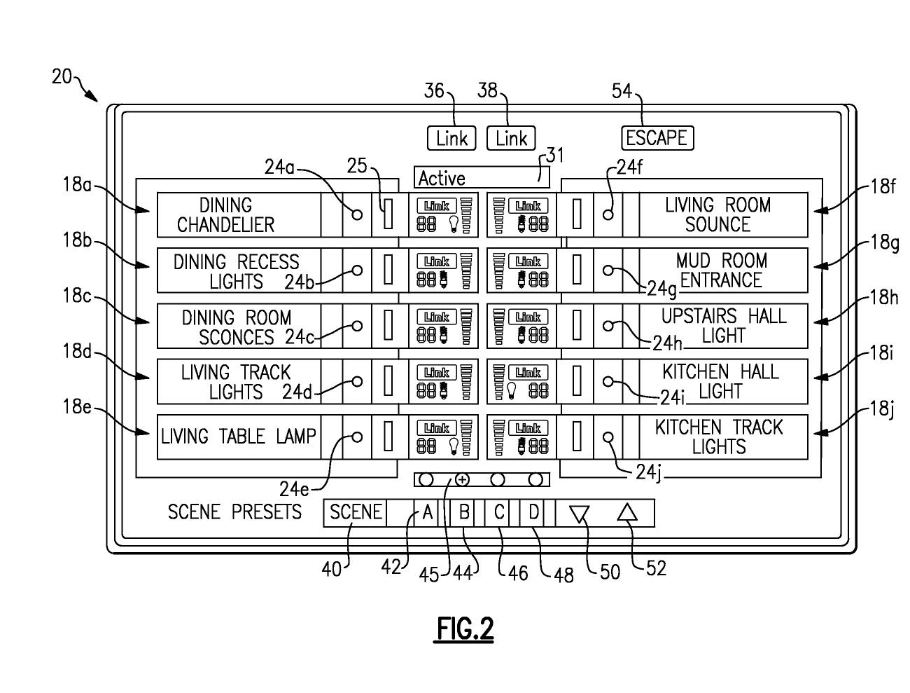

FIG. 1 schematically illustrates an example wireless battery-less switching application 10. A wireless battery-less switch 12 communicates with a receiver 14. One wireless battery-less switch is available from Verve Living Systems under Product No. X3100. The receiver 14 is coupled to a power source 16, and selectively provides power to a plurality of channels 18 in response to the signal from the switch 12 during an “active mode” in which a user may utilize a programmed system. In one example, the switch 12 has an ON portion 12a and an OFF portion 12b, and when the ON portion 12a is pressed the switch sends an ON signal, and when the OFF portion 12b is pressed the switch sends an OFF signal. In another example, a single press ON brightens a lighting load to the last level of dimness, a single press OFF fades a lighting load completely off, a double press ON instantly turns a lighting load 100% on, and a double press OFF instantly turns a lighting load off. A press and hold may provide a dimming or a brightening to a desired lighting level. The switch 12 may also be activated in a special pressing pattern, such as three successive presses, to perform a programming function. Although certain press patterns have been described above, it is understood that other press patterns could be used.

The receiver 14 communicates with a radio frequency (“RF”) processing module 21 which interacts with programming input devices such as button in the Display 20 as is shown in FIG. 2 and as will be discussed hereinbelow. The RF processing module 21 is available from Verve Living Systems under Product No. X2110. Although the example receiver 14 has multiple channels, it is understood that a receiver may have a single channel and may be coupled to more or less than two items. The channels 18 may be connected to a load, such as a lighting load or a switched receptacle.

Referring now to FIG. 2, a display 20 interacts with the RF processing module 21 in a number of ways to enable a user to quickly and efficiently set up the lighting controls and scenes in an environment (not shown) to be lit, shut off and/or dimmed as will be described herein. A scene is usually more than one lighting load that can be activated by one or more switches simultaneously.

The display 20 is a user interface of the RF module 21 that processes user inputs from the display. The interface includes a plurality of buttons, indicators and displays including channel indicators 18a-18j and their specific load indicators 19a-j, related press buttons 24a-j that each include an LED 25, a scene button 40, related specific scene buttons 42-48, dimness control buttons 50, 52, link button 36, unlink button 38, mode indicator 31 and an escape button 54

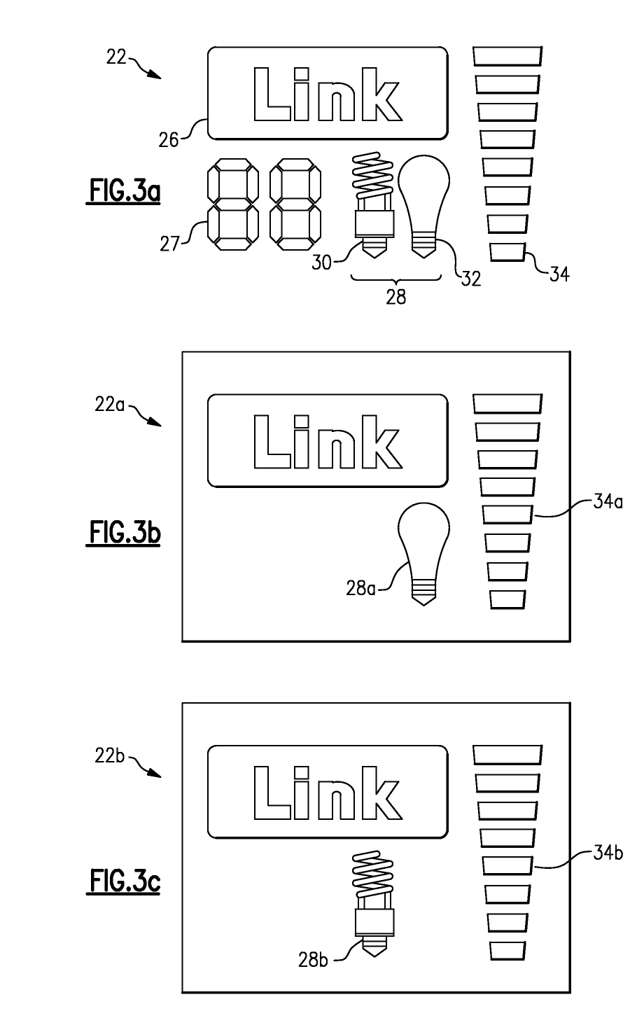

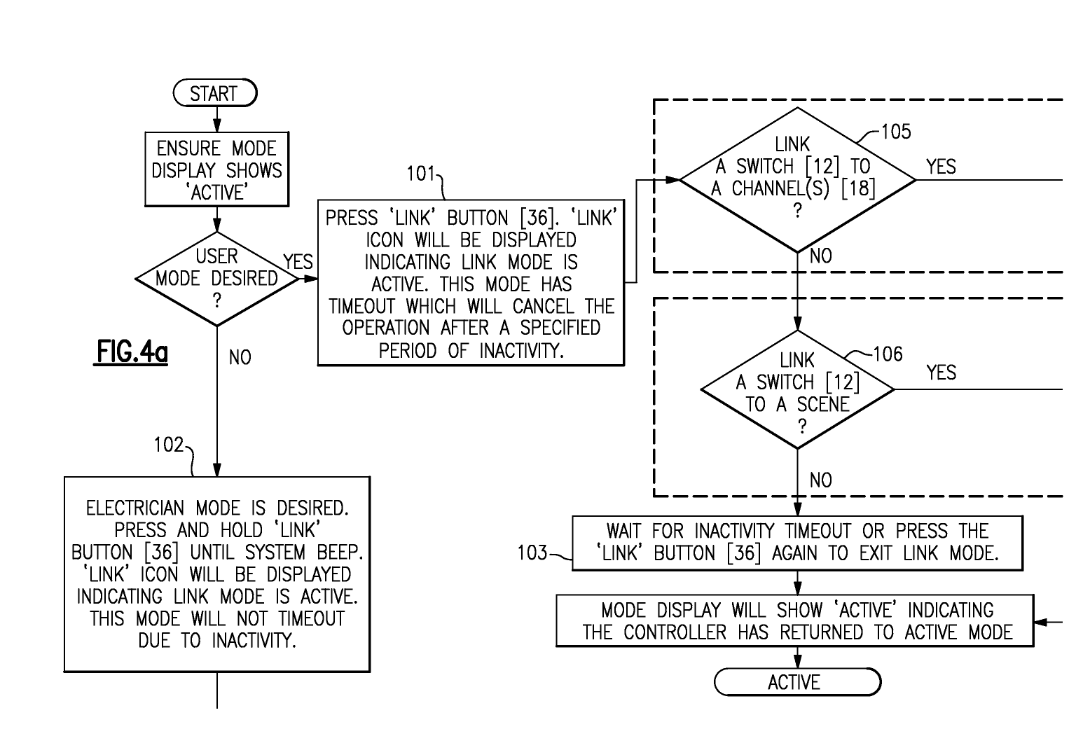

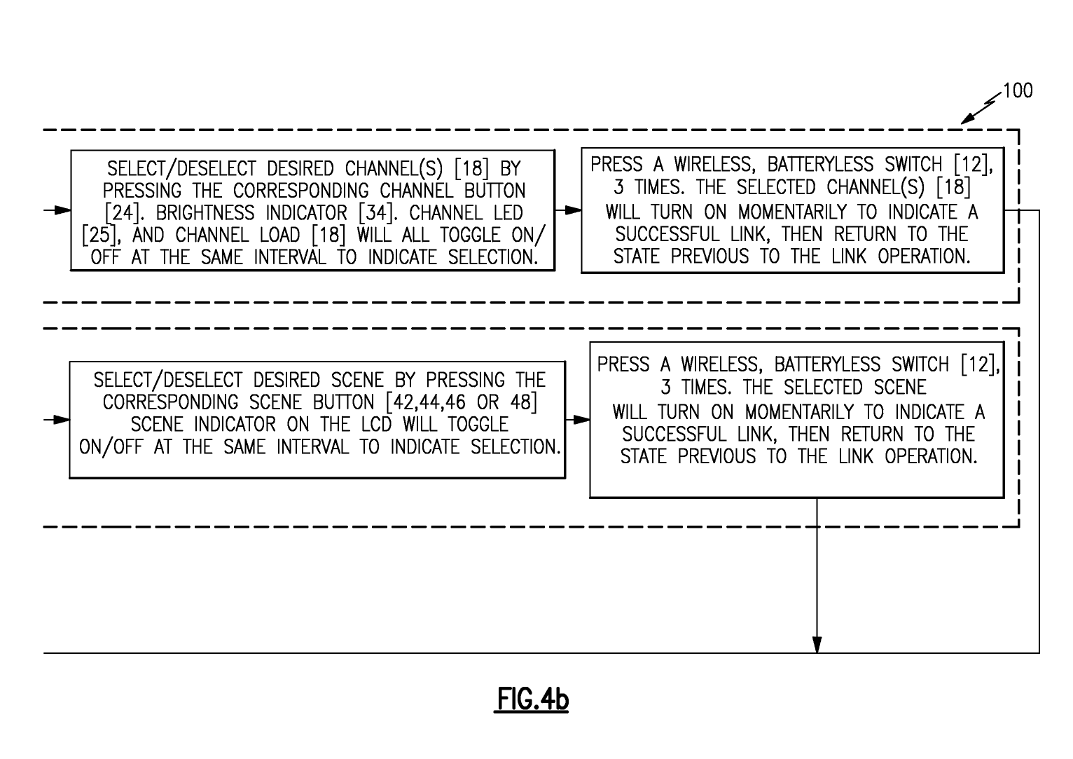

Referring to FIG. 3a the display 20 further includes channel display 22, a link indicator 26, a two digit connector display 27, a bulb-type indicator 28, and a dimness level indicator 34.

Referring back to FIG. 2, the user interface 20 includes a channel name 19, each channel name disposed in a readily useable manner such as an array, a channel display 22 (see also FIGS. 3a-c), and a channel button 24 for each of ten channels 18a-j. In this example, channels 18a-c correspond to dining room lights, channels 18d-f correspond to living room lights, channel 18g corresponds to a mud room entrance light, channel 18h corresponds to an upstairs hall light, and channels 18i-j correspond to kitchen lights. Each button 24a-j includes an adjacent indicator LED 25 to indicate a state of the channel by flashing, or by either on or off. Multiple RCs14 could be included in an environment, such as a house, building and or an outdoors, to facilitate control of more than ten channels in the environment. A window 31 indicates whether the module 21 is in the “active”, “linking”, or “unlinking” modes.

FIG. 3a illustrates an example display 22. The display includes a status indicator 26 indicating whether the channel is currently connected to a load, and a two digit display 27 that may display a quantity of switches linked to the channel. However, it is understood that other quantities of digits could be displayed. In one example the maximum number of switches that may be linked to a channel is thirty. The display 22 also includes a bulb type 28 indicating whether a lighting load is an energy-saving compact fluorescent bulb 30 or an incandescent bulb 32. A brightness indicator 34 illuminates a power level of the lighting load connected to the channel by varying power to change the dimness of the load.

FIG. 3b illustrates channel one display 22a and FIG. 3c illustrates channel two display 22b. The displays 22a-b omit the quantity of linked switches 27, however it is understood that this could also be displayed. The displays 22a-b are at a full brightness level (see 34a-b). Display 22a corresponds to an incandescent lighting load 32, and display 22b corresponds to an energy-saving bulb load 30 such as a compact fluorescent bulb though one of ordinary skill in the art would recognize that the use of other energy saving bulbs are appropriate for use herein.

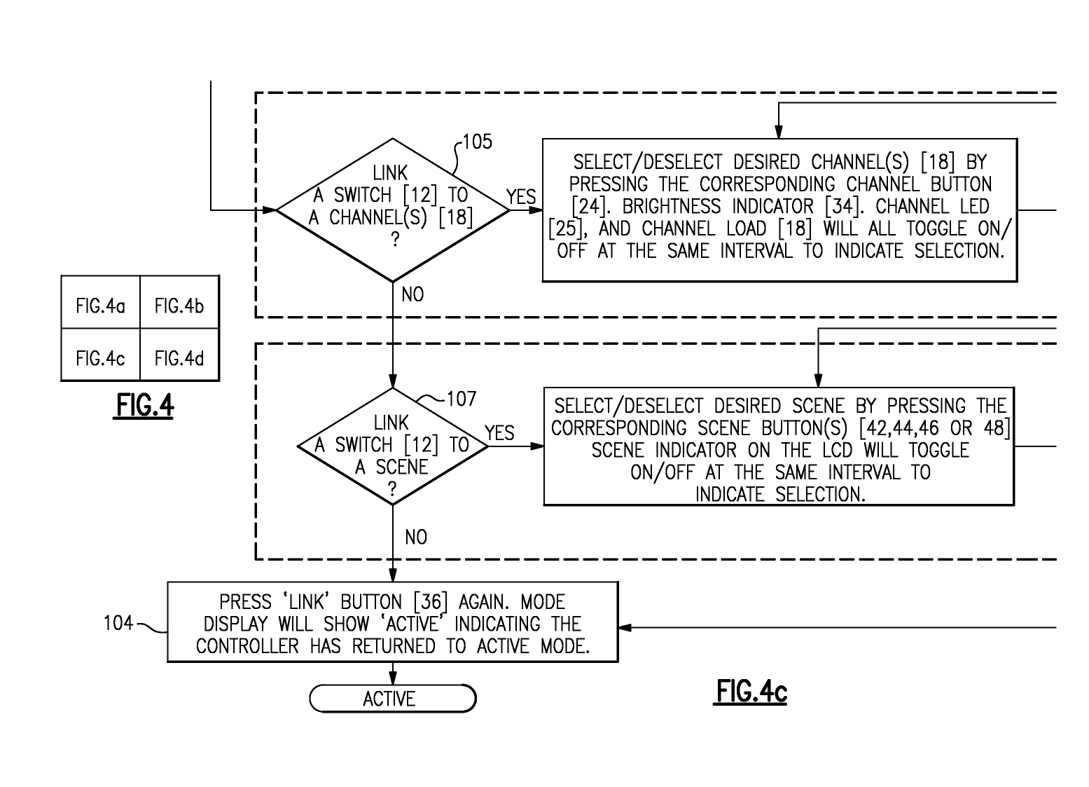

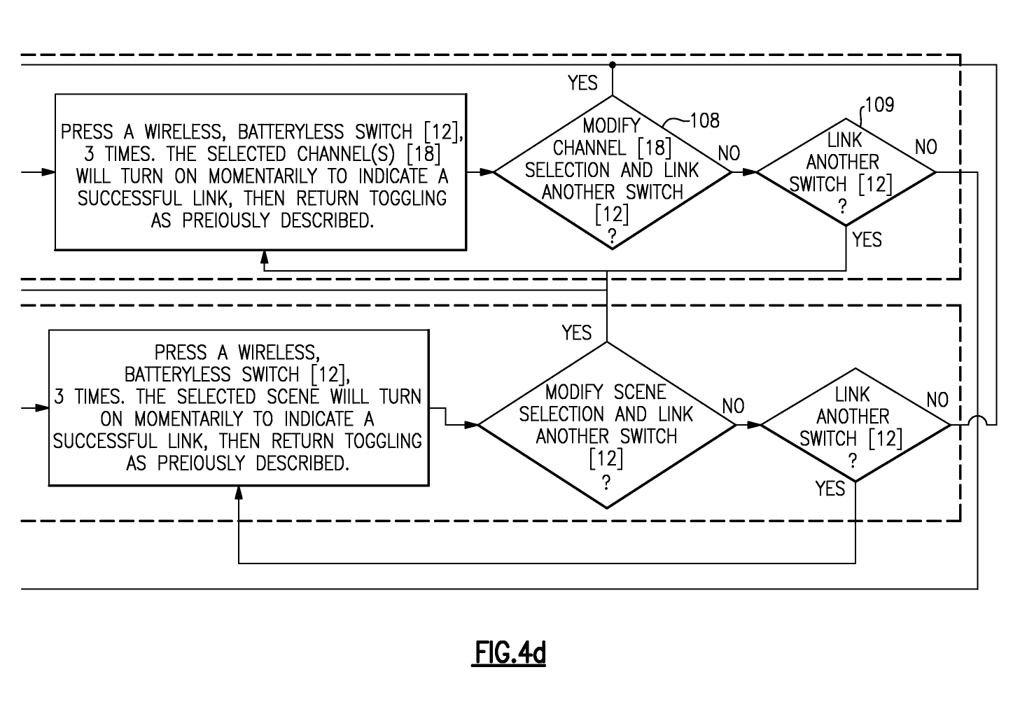

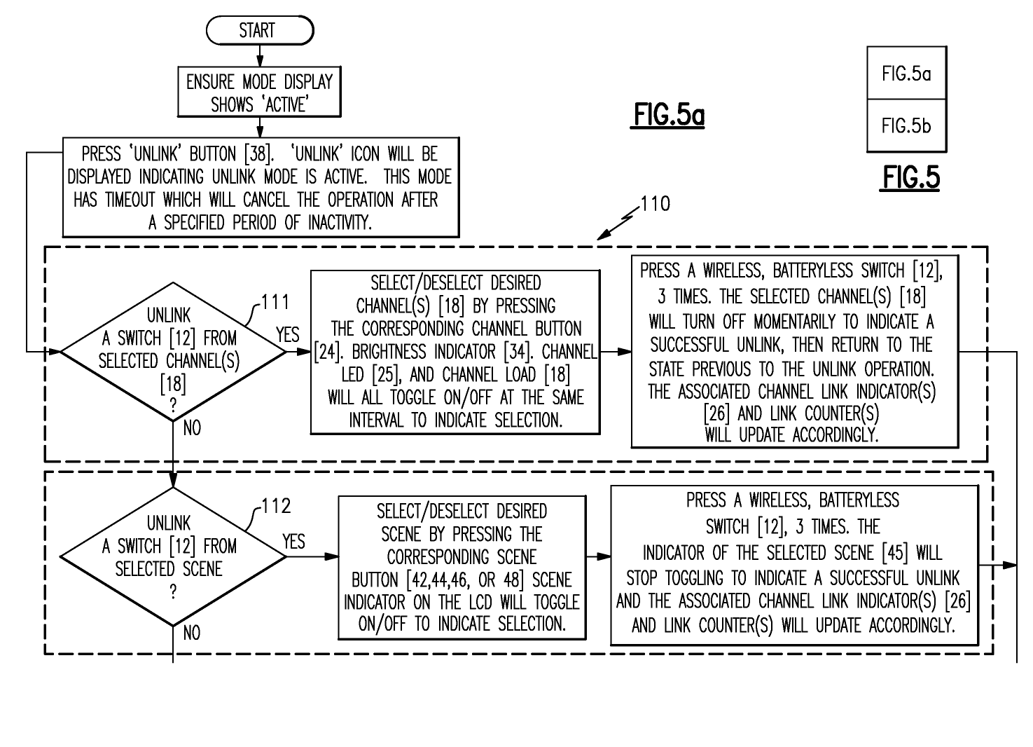

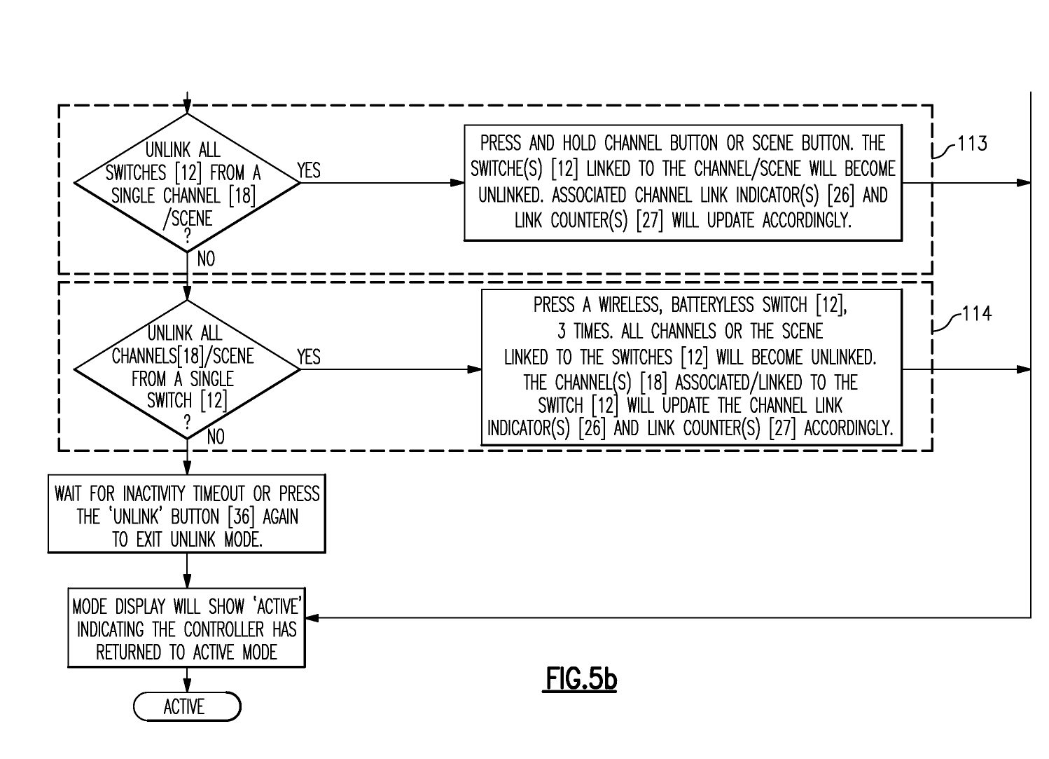

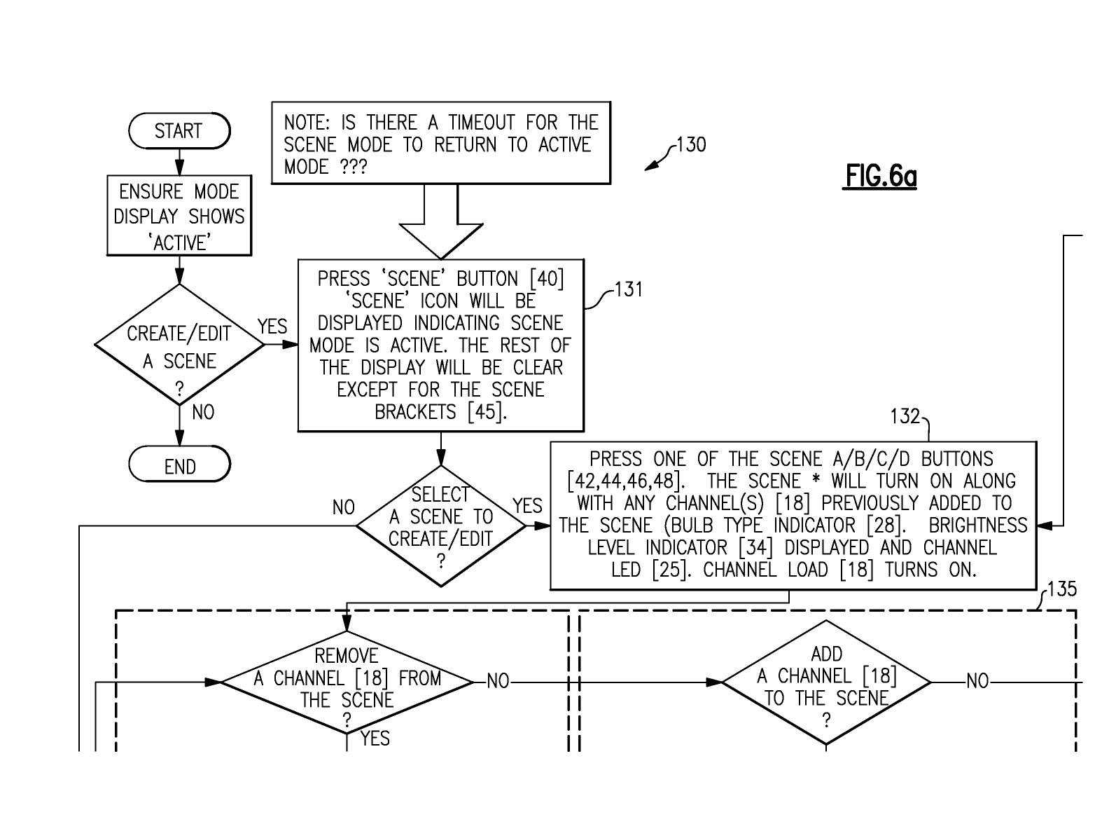

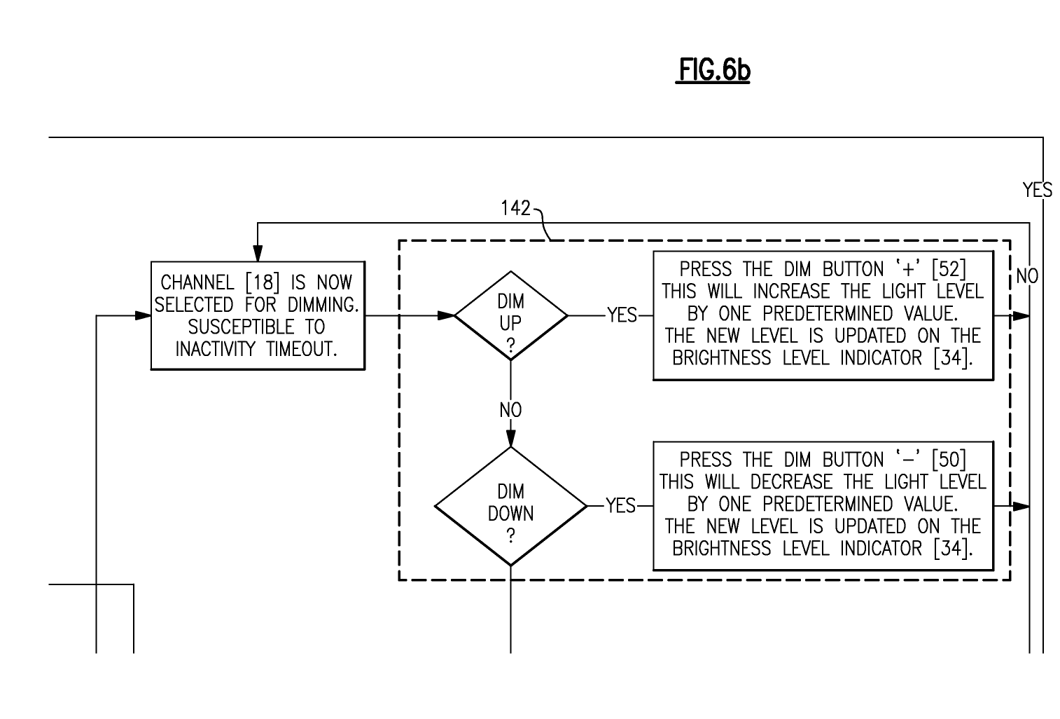

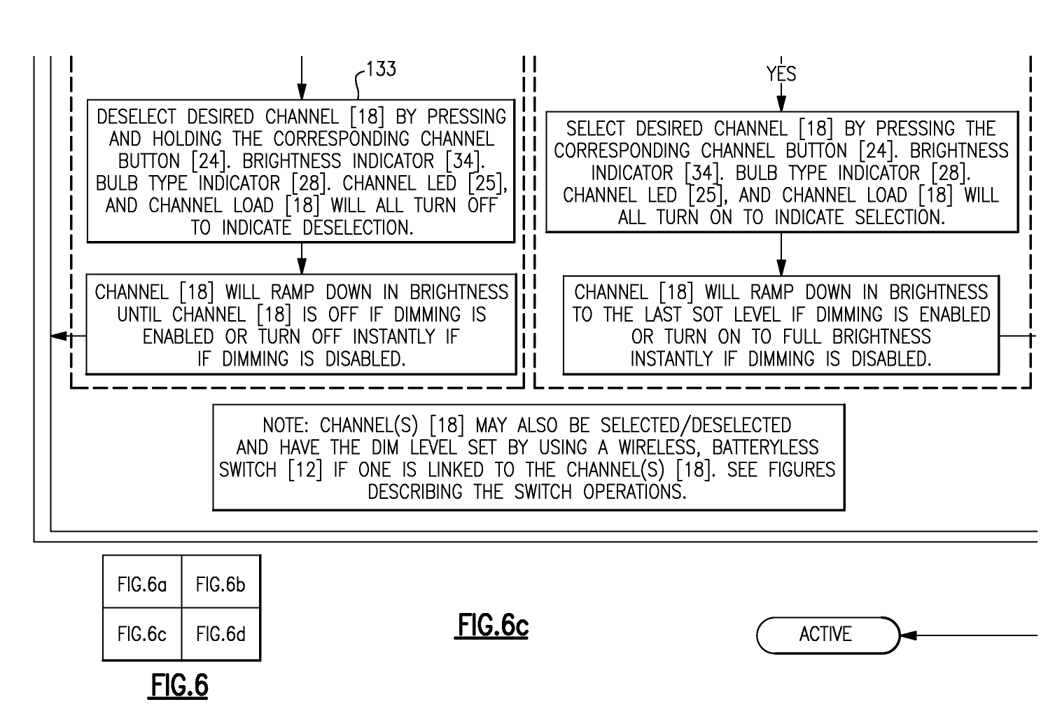

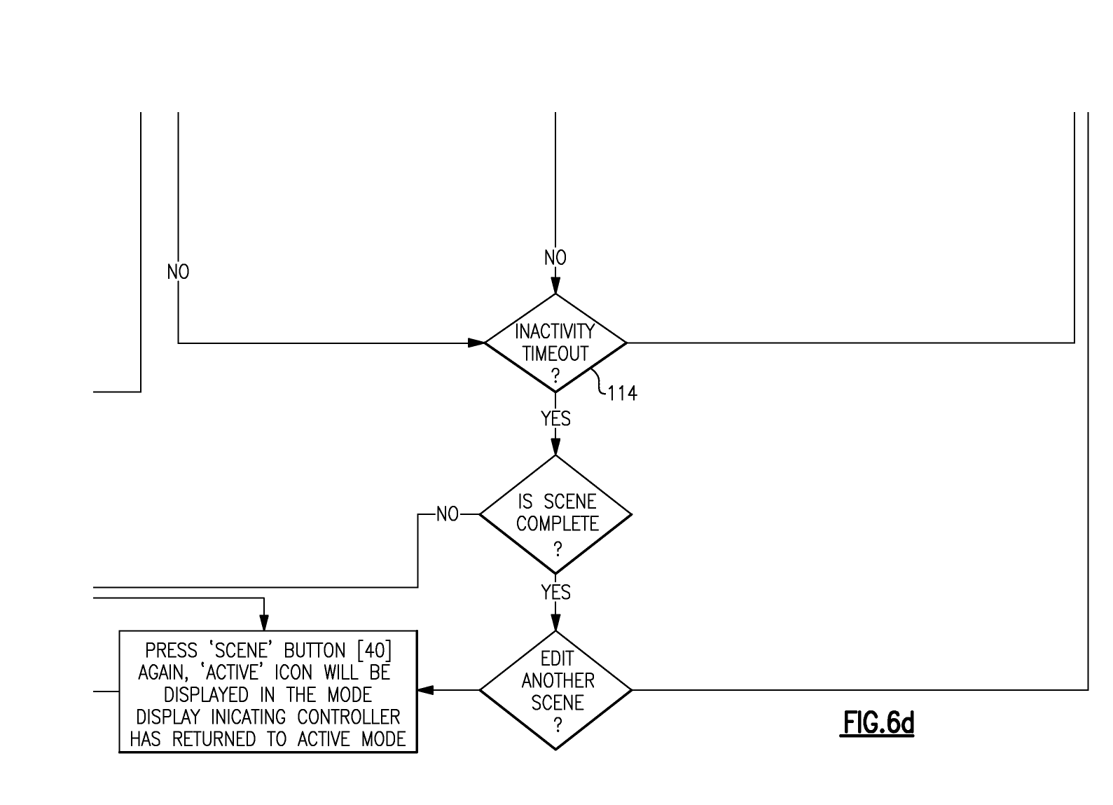

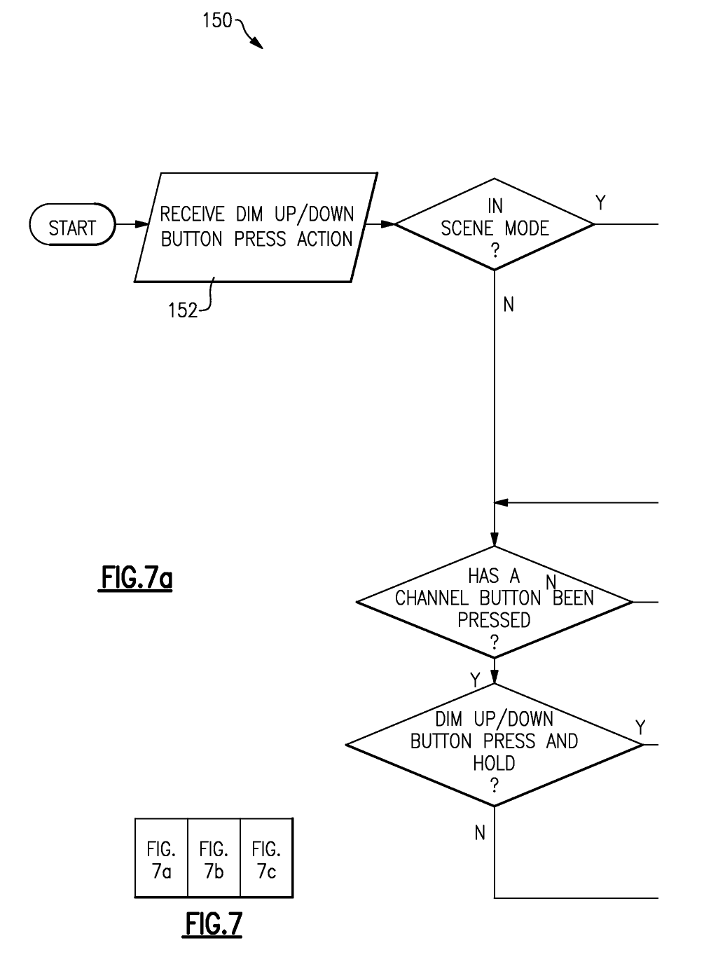

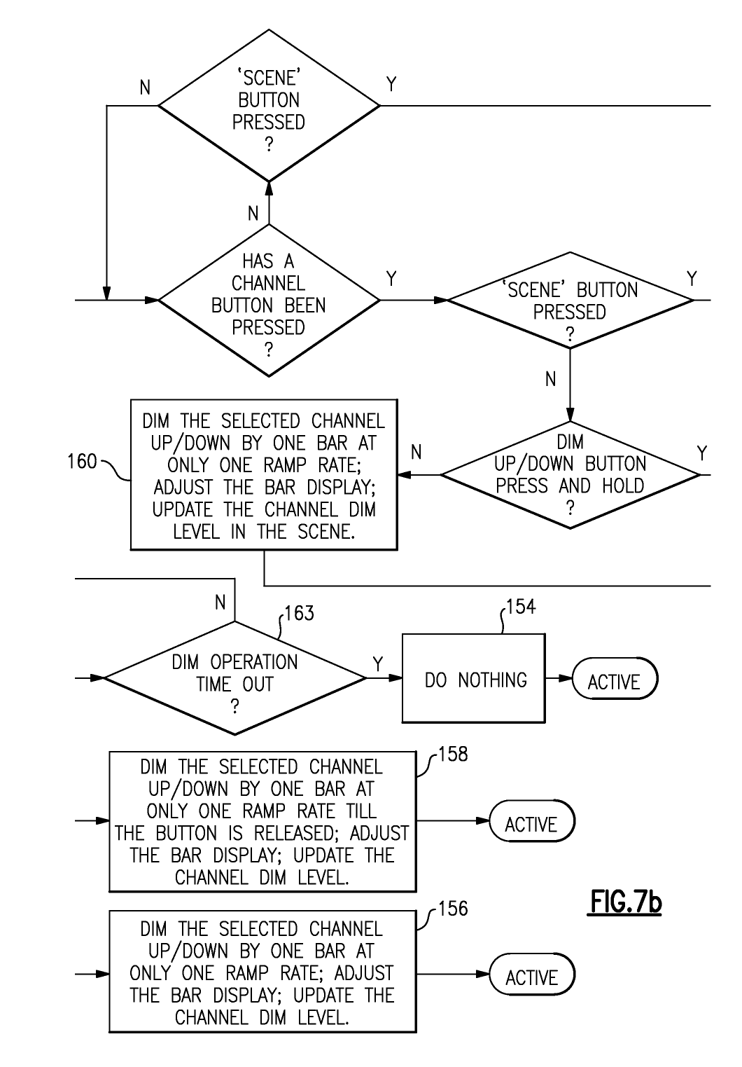

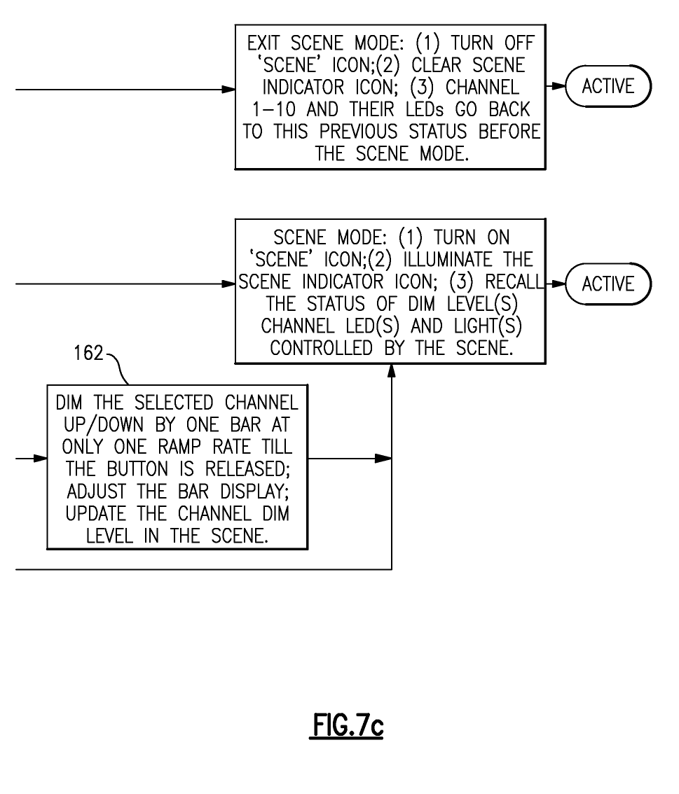

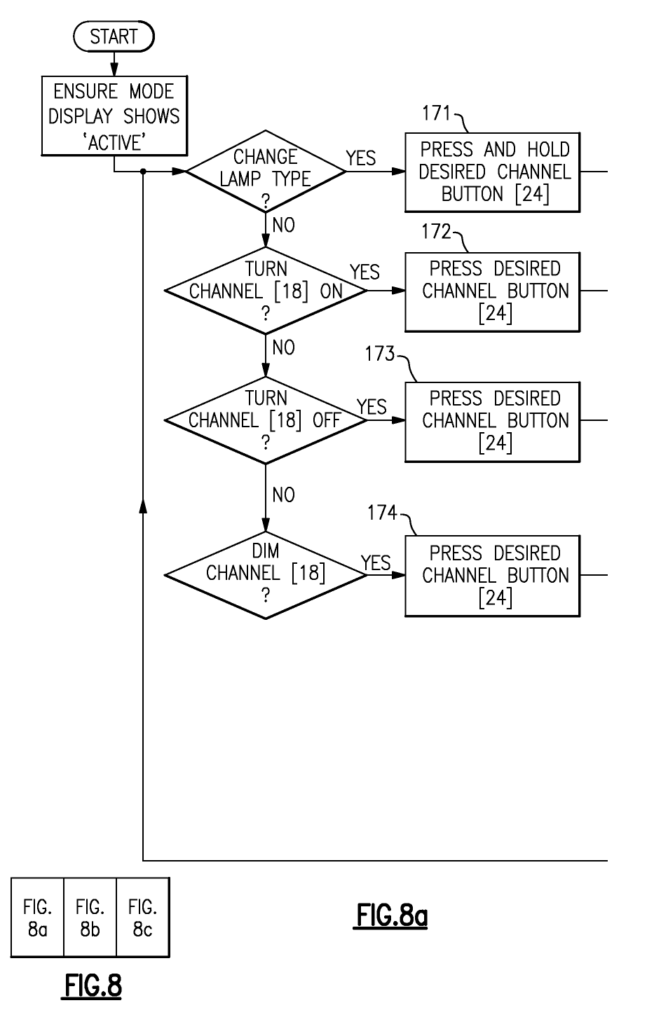

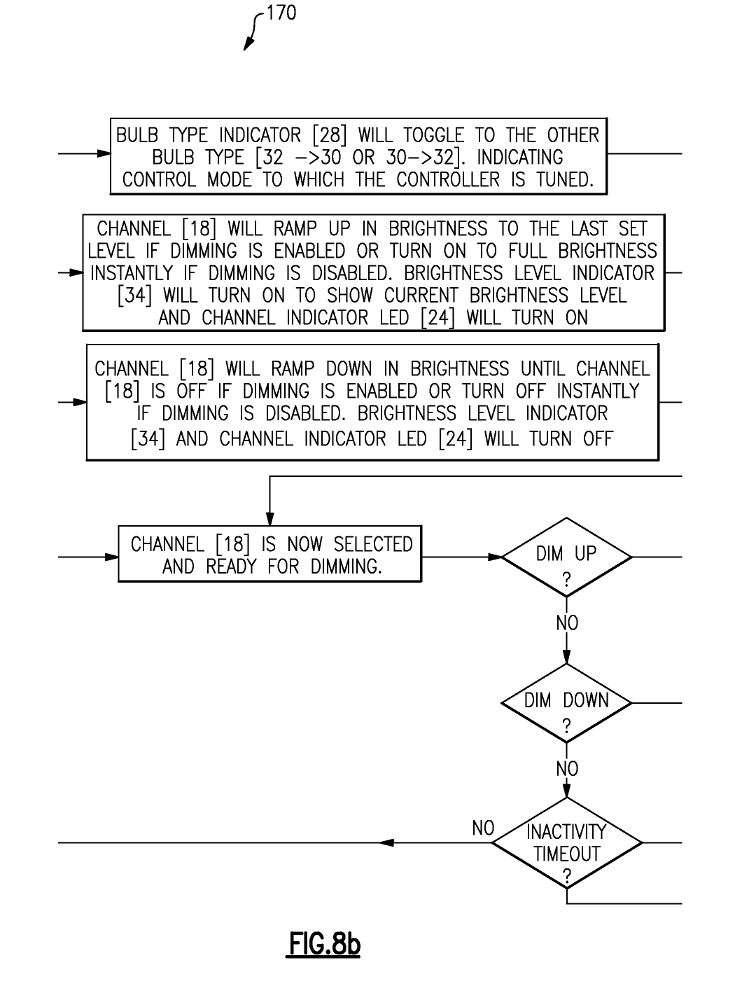

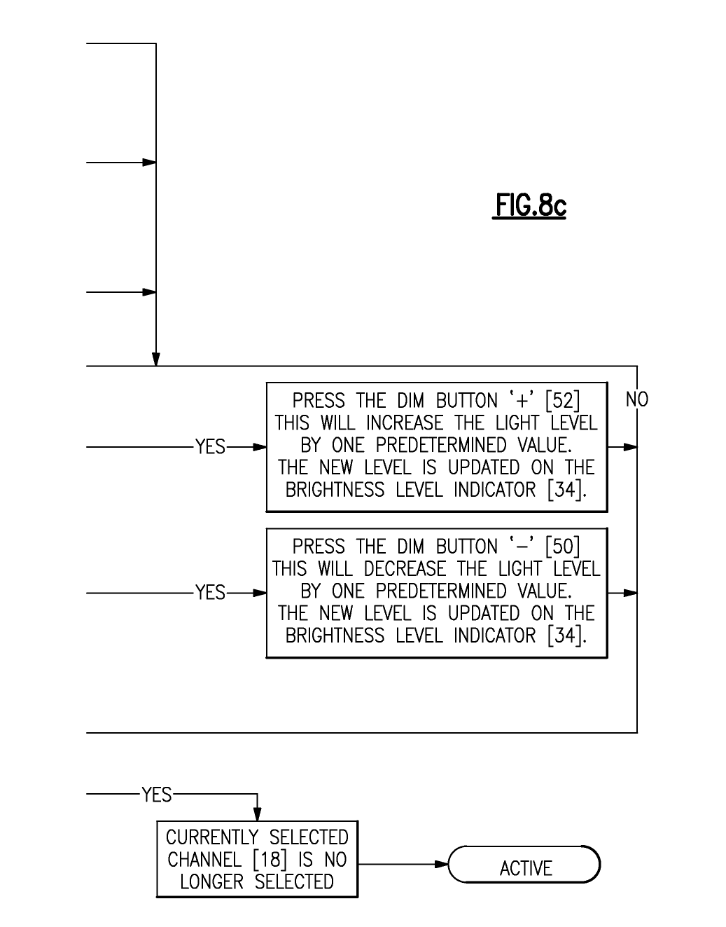

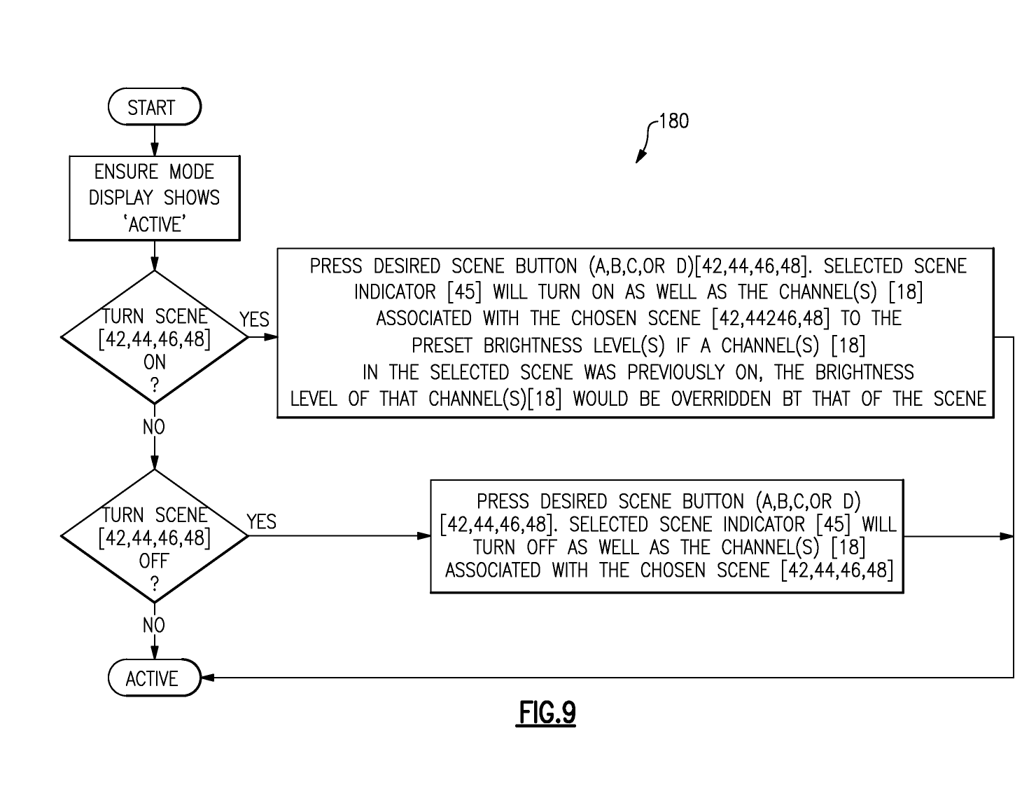

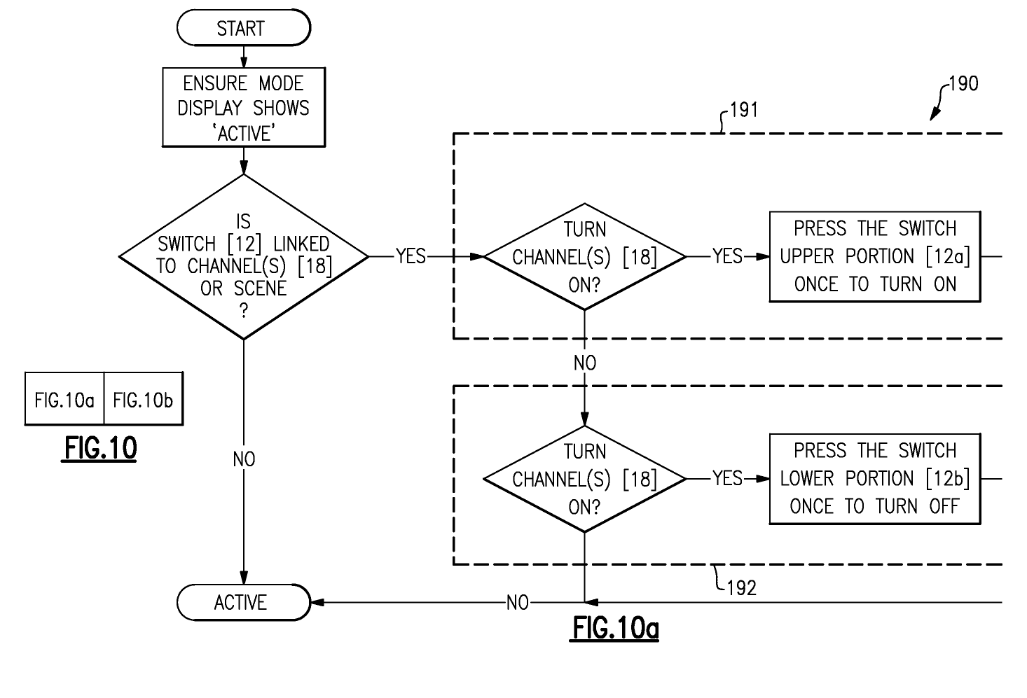

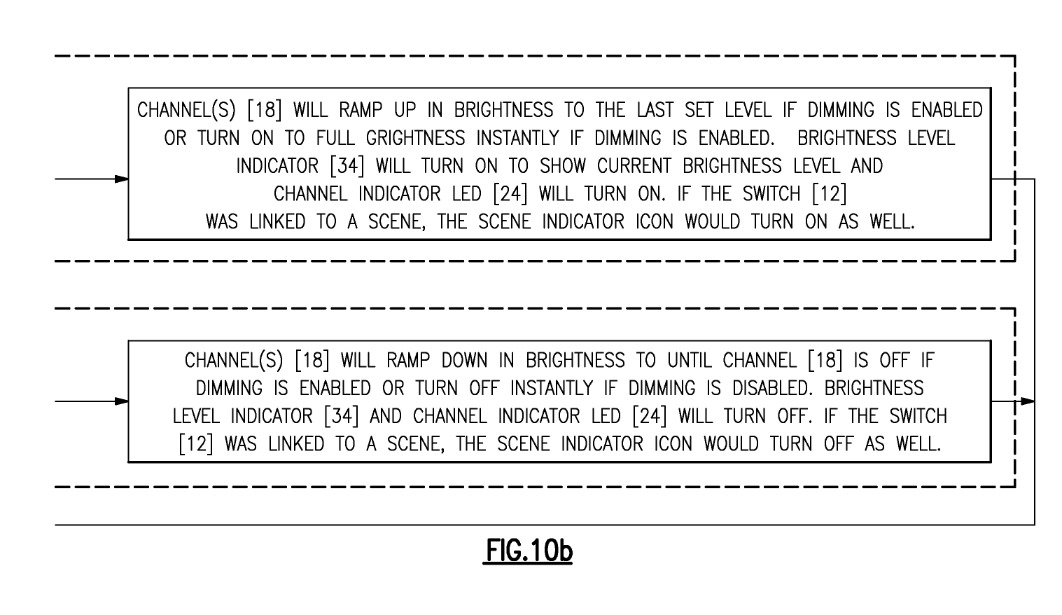

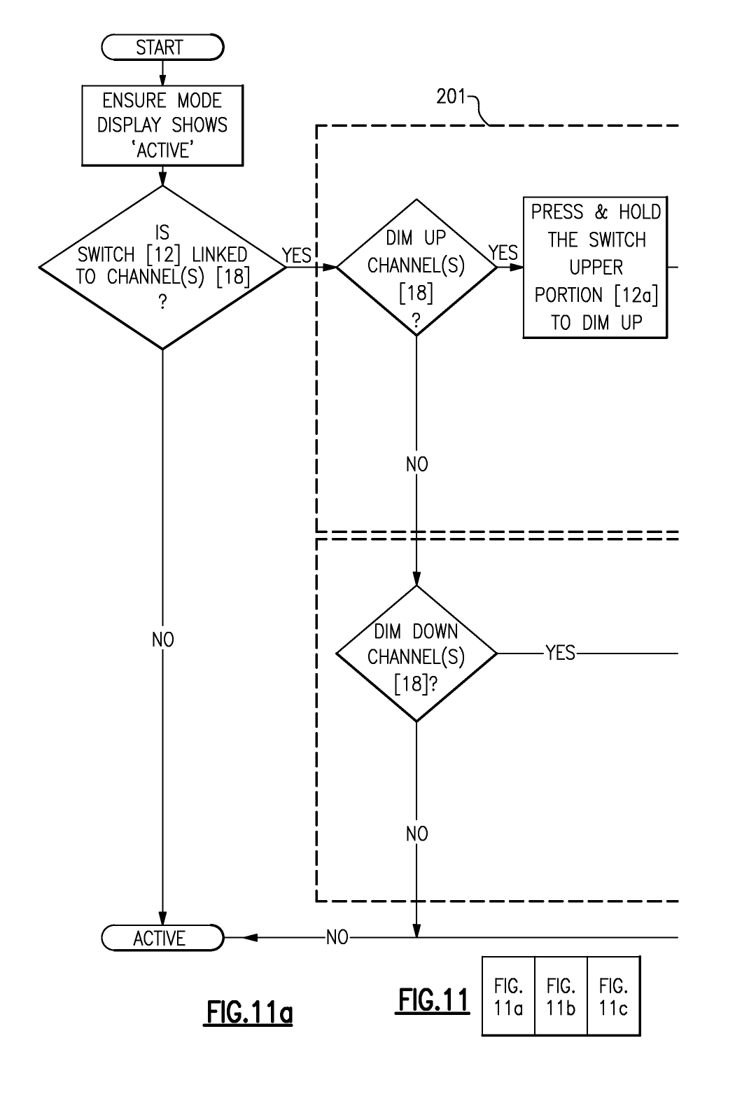

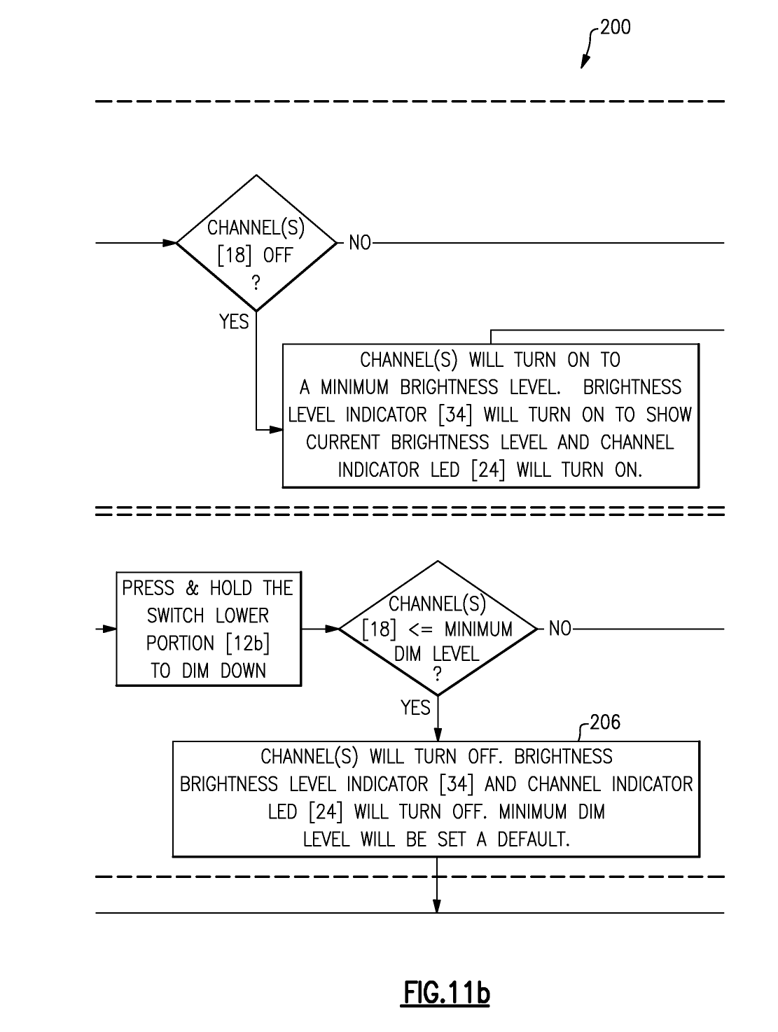

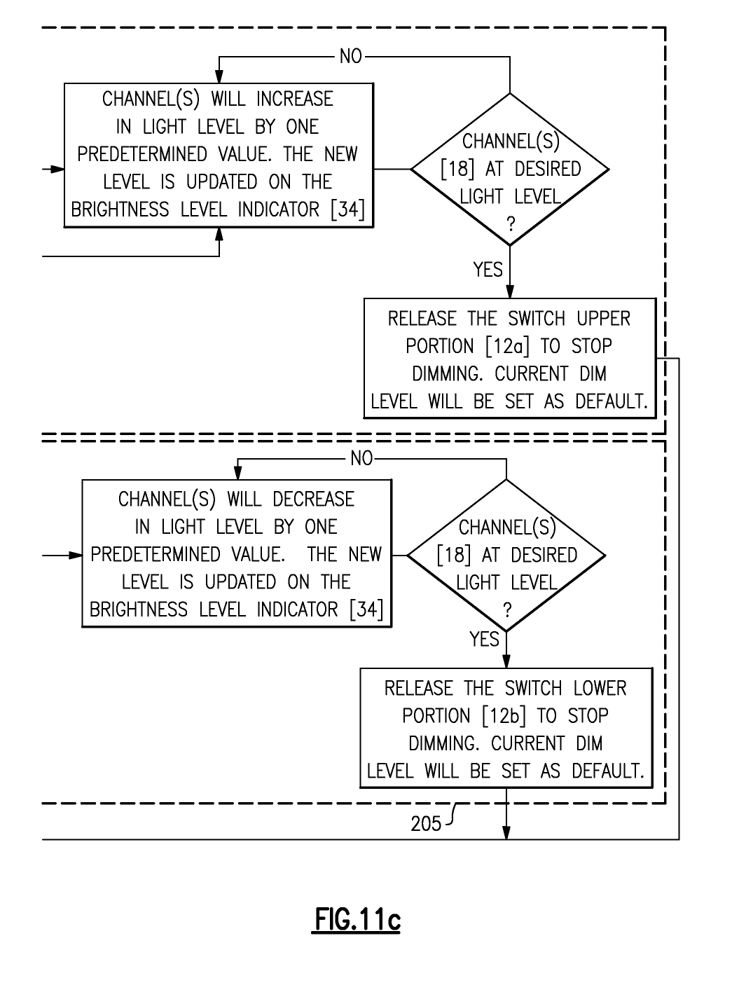

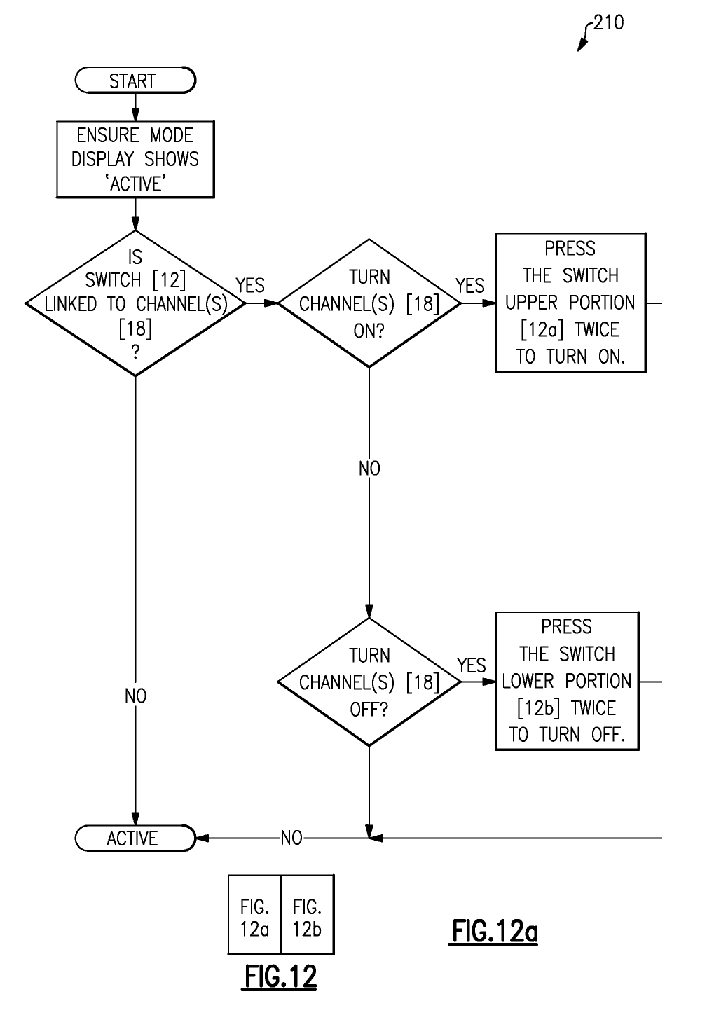

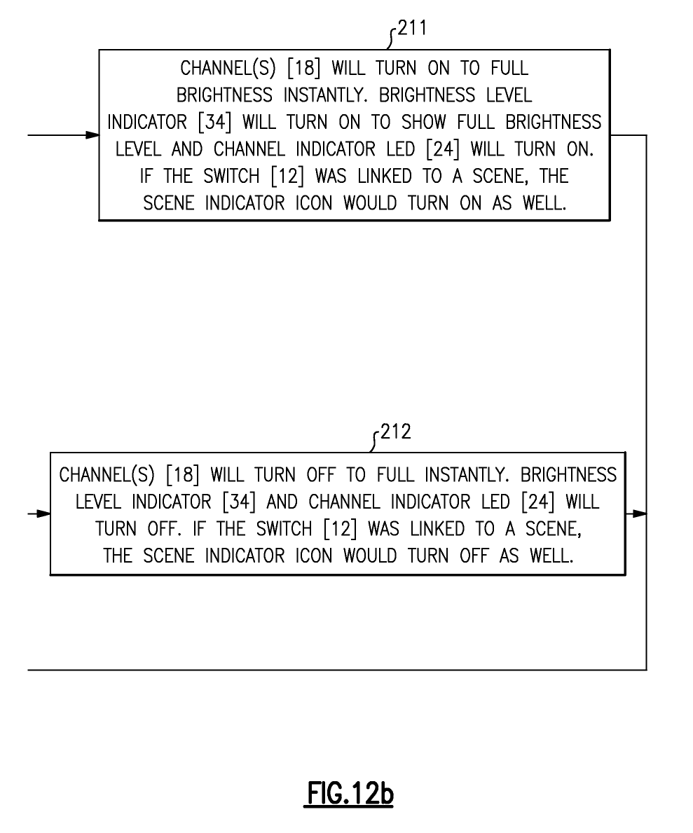

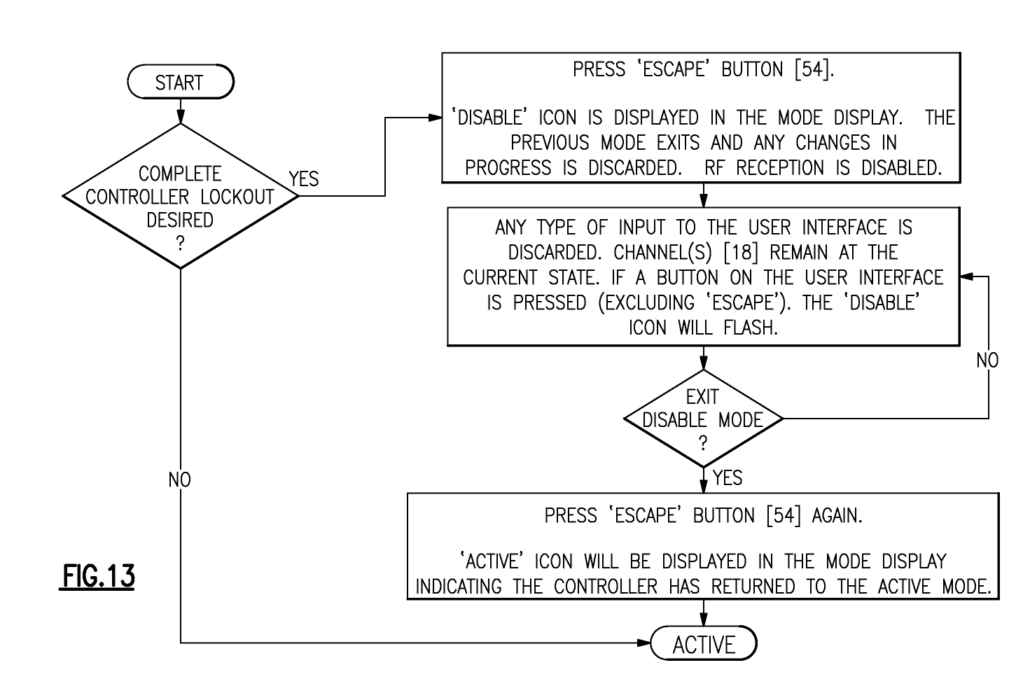

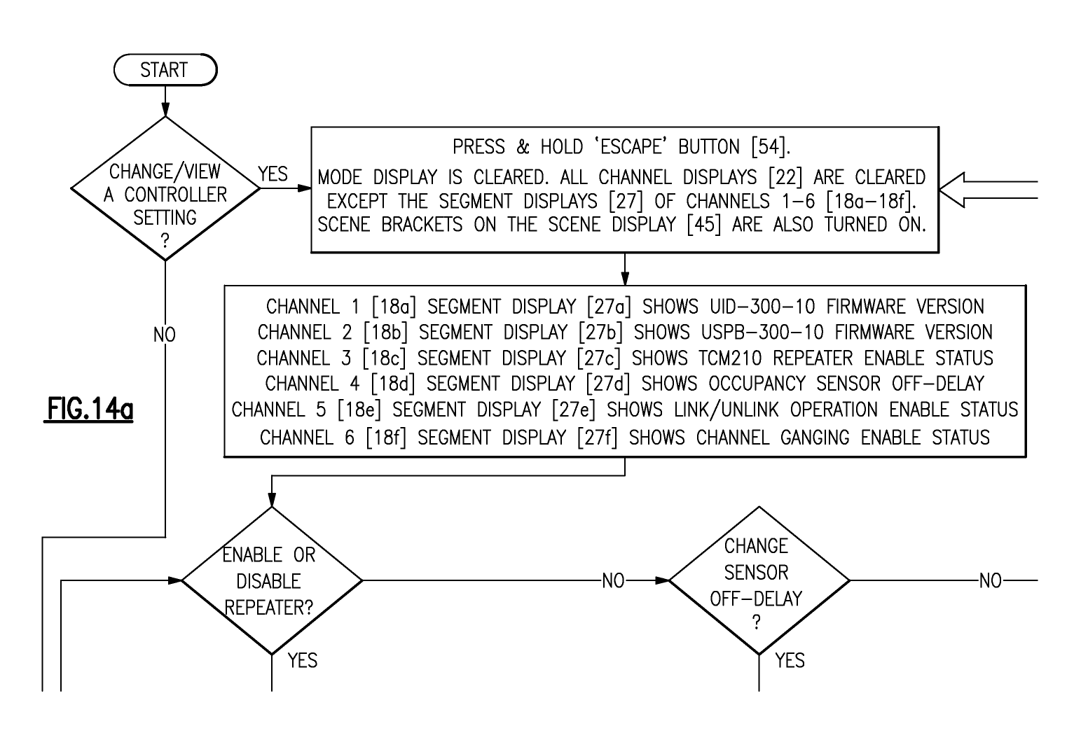

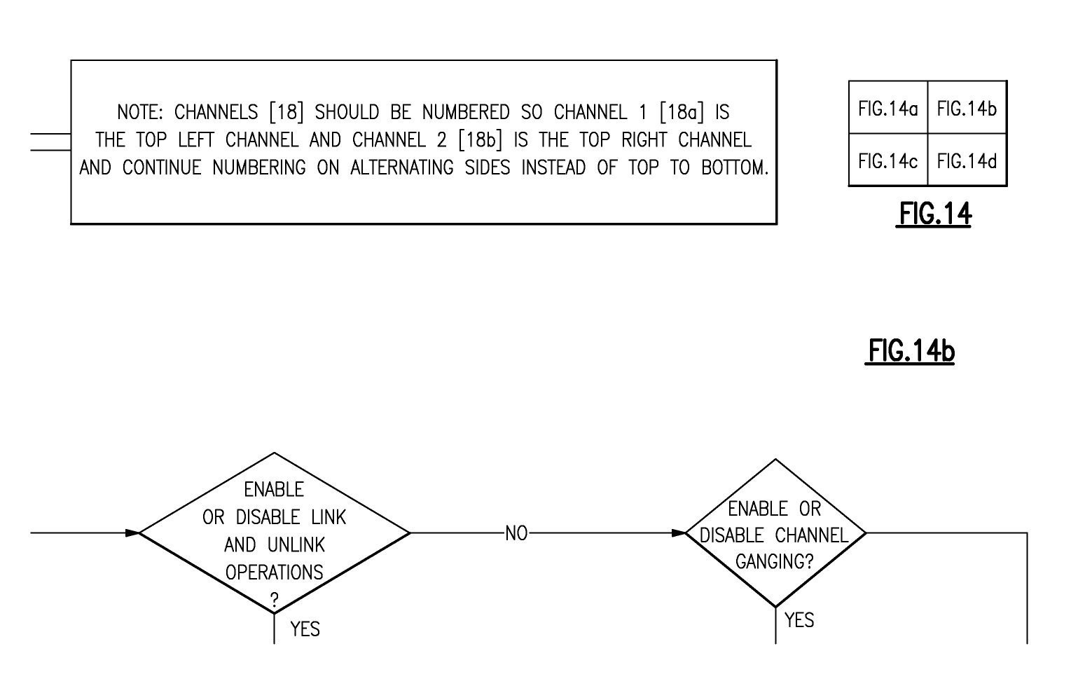

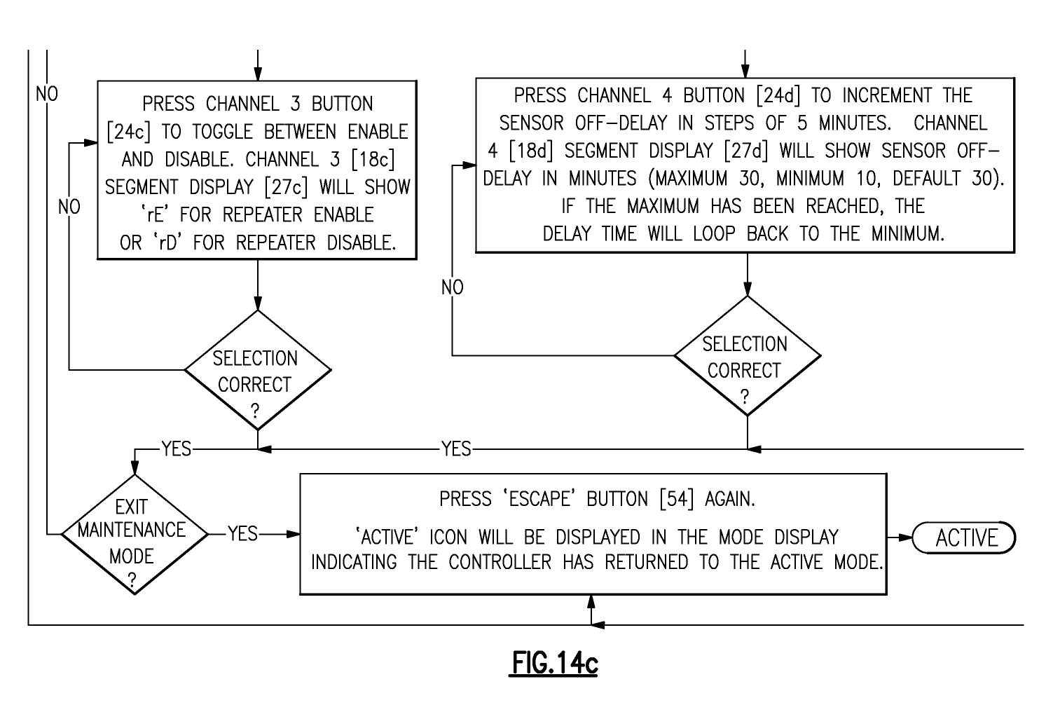

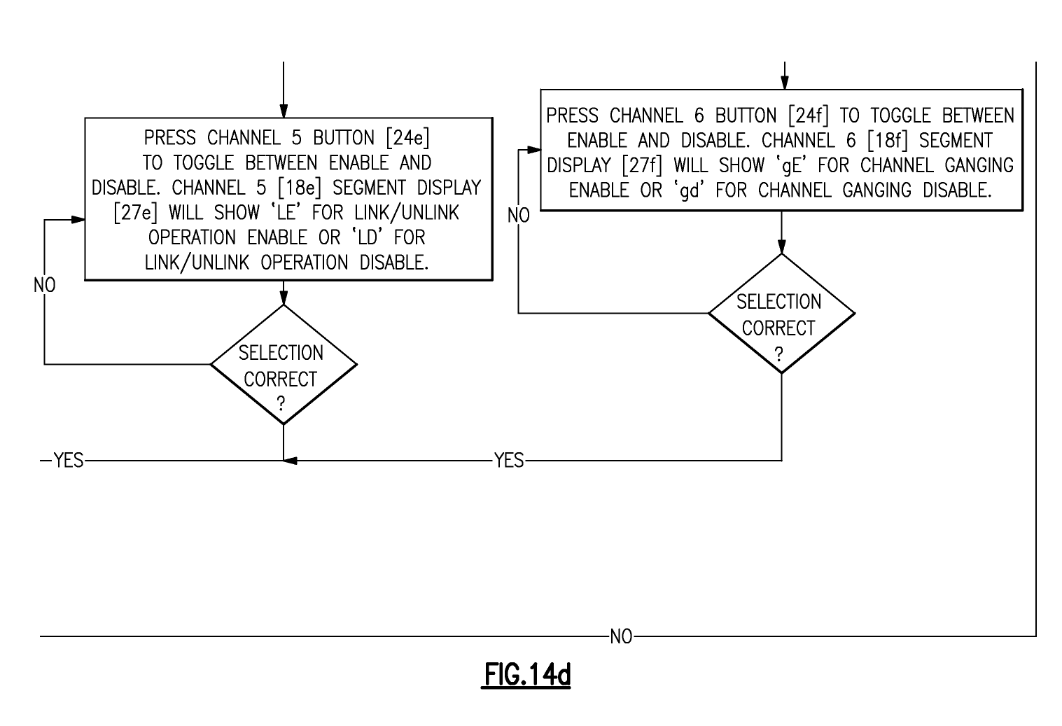

As will be shown herein, the user has several options to use/program the RC to achieve his or her lighting requirements. For instance, programming a lighting load may be initiated and achieved by pressing the link button 36 as described in FIG. 4, pressing the scene button 40 as described in FIG. 6, pressing the channel button 18 as shown in FIG. 8 or by holding and pressing the scene button 40 as shown in FIG. 9. Similarly, dimming can be achieved by pressing a dimming button 50, 52 as shown in FIG. 7 or by pressing and holding a switch button for a period of time as is shown in FIG. 11. A load may be unlinked by pressing the unlink button 38 as described in FIG. 5 or by pressing a channel button 18a-j as described in FIG. 8. The single press of a switch may be used to turn a load on to a preset level or off as shown in FIG. 10, dim or brighten a load if it is pressed and held as shown in FIG. 7, or a switch double press can instantly turn a load fully on or off as described in FIG. 12.

As a first step to programming, a user must place the RC in the proper mode by viewing mode display 31 and the escape button 51. If the mode display is not in the required mode (e.g., the linking, unlinking, scene or active modes) or if the disable icon is illuminated, a user must first place the system in active mode by pressing the button referring to the mode that the system is in. For instance, if the window is illuminated to indicate that the RC is in the escape mode, the escape button must be pressed to return to the active mode. Similarly if the system mode display indicates the system is in the unlinking mode, unlinking button 38 must be pressed to return to active mode, etc.

FIGS. 4A-4D schematically illustrate a switch linking process 100, in which a self-energizing switch 12 can be linked to a channel 18 and thereby a load via either a “user linking mode” or an “electrician linking mode”. The user linking mode 101 is intended for use when fewer loads or combinations of loads and lighting levels (“scenes”) are to be programmed and the electrician linking mode 102 is intended for use when comparatively more loads or combinations of loads are to be programmed though either process can be used for fewer or more programming. However, the user linking mode will time out as shown in step 103 to return to active mode while the electrician linking mode requires a user to take action to return to active mode as shown in step 104.

To enter either programming mode, a user presses link button 36 (steps 101 and 102). The term “Linking” or the like appears in mode window 31 (see FIG. 2 and FIG. 3A-3C). If the user presses and releases the link button 36, the system enters the “user linking mode” (step 101). If the link button 36 is pressed and held for a short period of time, the system enters the “electrician linking mode” (step 102). Upon entering either mode and until the channels are selected, all LEDs 25 relating to channels 18a-j flash.

Using the example of channel 18a, a user presses and holds the link button 36 (putting the system in electrician mode), and, if a user so desires (Step 105 et seq), then presses the channel button 24a for channel 18a that corresponds to a dining room chandelier. The dining room chandelier starts flashing ON and OFF in coordination with its Channel LED 25. Upon activation of a switch (step 105) three times, such as the switch 12, the dining room chandelier turns fully on for a predetermined period of time, and then returns to a previous lighting level that may have been dimmed. The switch 12 is then linked to channel 18a and is operable to control the power delivered to the dining room chandelier. In the user mode however, the RC returns to active mode immediately after linking the switch and the mode display shows “active”. Because the electrician mode does not time out, the user can continue to link additional switches to the selected channels. A user may exit the electrician mode by pressing the link button again (step 104).

In the user mode (step 106) the process is similar, except that if too much time passes without action by the user, the RC times out (step 103) by exiting the “linking mode” and entering “active mode.” The process 100 may be repeated to link a single switch 12 to multiple channels 18, or to link multiple switches 12 to a single or multiple channels 18.

A user also has the option in either the user (step 106) or electrician mode (step 107), if desired, to create scenes by pressing any of scene buttons 42, 44, 46, or 48. In the regular mode, after selecting one of the channels and three presses from switch 12 adds the switch and related channel to the scene. In the electrician mode (step 107) after pressing a channel and a switch three times as shown in step 106, the system gives the user an opportunity to add another channel to the scene (step 108) or another switch to the channel. Dimming that scene however is controlled by the process shown in FIG. 6 as will be discussed herein. A user exits the electrician mode by pressing the link button a second time (step 104)

FIGS. 5A and 5B schematically illustrates a switch un-linking process 110. A user presses unlink button 38 (step 112) and the term “unlinking” or the like appears in the mode window 31 (see FIG. 2). If a user wishes to unlink a switch 12 from a single channel 18 (step 111), the user selects a channel button and then presses a linked switch 12 three times to unlink the two. If a user wished to unlink a switch from a scene (step 112), the user presses a scene button 42-48 and then presses a switch 12 three times to remove that switch from the scene. If a user wishes to disconnect all switches from a channel or a scene (step 113), the user presses and holds either the associated channel button or a scene button and all switches associated with that channel or that scene are unlinked therefrom. If a user wishes to disconnect all channels or a scenes from a switch (step 114), a user in the unlink mode simply presses related switch 12 three times. The unlink mode after an action described above simply times out to allow the processing module 21 to return the user interface to the active mode.

FIGS. 6A-6D schematically illustrate a scene programming process 130 corresponding to the scene button 40, scene selection buttons 42, 44, 46, 48, and dimming buttons 50, 52. The method 130 may be performed to program a “scene” so that one of the scene buttons 42-48 activates multiple channels of lighting at predetermined dimming levels for each selected channel. Scene button 40 is activated (step 131). A user then presses a scene selection button 42-48 to select a scene (step 132), at which time an illuminated asterisk 45 (see FIG. 2) will appear above the selected scene button. A channel is deselected by pressing and holding the channel button at which point all channel indicators are turned off to indicate deselection (step 133). The loads associated with the channel will dim to off if dimming is enabled or go to off if dimming is not enabled (step 144). A channel may be added to the scene (step 135) by pressing the related channel button at which point all channel indicators will go to on (step 136) if no dimming is programmed or ramp up to the previous level of brightness if dimming has been enabled.

Once a channel has been added, the RC utilizes dimming buttons 50, 52 to increase or decrease a brightness of a channel and its corresponding power indicator 34 (step 142) so that the scene includes dimming as required by a user. If a user does not press anything for a predetermined amount of time after pressing the scene button to add a channel, then the process may time out (step 144) and the user interface 20 may return to “active mode.”

FIGS. 7A-7C schematically illustrate a process 150 for using the dim buttons 50, 52 buttons (step 152). If the user interface 20 is not in scene mode and a channel button 24 has not been pressed, then the user interface does nothing (step 154). If the user interface 20 is not in scene mode and a channel button 24 has been pressed, then dim button 50 will decrease the brightness indicator 34 for the selected channel (step 156) by one step (several step changes result in one bar change) and will also similarly decrease a brightness of a lighting load coupled to the selected channel. If the user interface 20 is not in scene mode and a channel button 24 has been pressed, the dim button 52 will increase the brightness indicator 34 for the selected channel (step 158) by one step (several step changes result in one bar change) and will also increase a brightness of a lighting load coupled to the selected channel. If the user interface is in scene mode, and a channel has been selected, then the dim buttons 50, 52 will increase or decrease the brightness of the channel within the scene (steps 160, 162). If a user does not press anything for a predetermined amount of time after pressing one of the dim buttons 50, 52 (step 152), then the process may time out (step 163) and the user interface 20 may return to “active mode.”

FIGS. 8A-8C schematically illustrate a process 170 for using the channel buttons 24a-24j. If a bulb type is changed (step 171) as shown in FIG. 3a, a channel button linked to that bulb is pressed and held the indicator 28 will toggle to the other bulb type. If a user desires to turn on the loads linked to a channel (step 172), the channel button is pressed to turn on the linked loads to their previous brightness level. If a user desires to turn off the loads associated with a channel (step 173), a user presses the channel button to turn off all lighting loads associated with the channel

If a user desires to dim the lighting loads associated with a channel (step 174), a user presses channel button and then uses the buttons 50, 52 to either dim the channel up or down by one step increments. After any of the actions in steps 171-174, the RC will time out and return to active mode.

FIG. 9 shows a way 180 to utilize the scene buttons 42-48. If a user desires to turn a scene on, the user presses any of scene button 42-48 and the related channels will turn on at the set levels of brightness. If any of the scene lights were already on, they will change to the current scene setting levels of brightness. If it is desired to turn a scene off, similarly, a press of the appropriate scene button will turn the scene off.

FIGS. 10-12 schematically illustrate a number of ways to utilize the battery-less wireless switch 12 along with the RC in the lighting system; e.g., a single press, a press and hold, a double press, and a triple (or other sequences and combinations, as one of ordinary skill in the art would readily appreciate) may be used to achieve a user's requirements.

FIGS. 10A and 10B show how switch single presses are interpreted by controller 21 (see FIG. 1) 190. If a single press of switch 12 is received to turn the channels linked to the switch ON (step 191), the channels and the associated lighting loads are turned on to the last programmed level of brightness. If the load was on and dimmed, it will turn instantly on. Similarly, if a single press of switch 12 is received to turn the channels linked to the switch OFF (step 192), the channels and the associated lighting loads are turned off. If the load was previously dimmed, it will dim down to off.

Further referring to FIGS. 11A-11C, a method of utilizing switch single press is shown 200. If a switch is linked to a channel and a user desires the lighting levels to be higher (step 201), a switch is pressed and held ON, the channel will dim up at one rate (step 201) from its existing state. The switch is held until the desired degree of dimming is achieved. If a switch is linked to a channel(s), and the switch is pressed and held OFF, then all linked channels to the switch are dimmed down at one rate (step 202) from their previous existing state. If the channel is dimmed down to an OFF state, a minimum level of brightness is used as a default position for the channel when it is turned on (step 206).

Referring now to FIGS. 12A and 12B, a method 210 of utilizing a double press for controlling the channels 18 and scenes 42-48 is shown. If a switch 12 is double pressed ON and the switch is linked to a channel or a scene, the channel or scene will be moved to full power instantly without any ramping up (step 211). Similarly, if the double press is OFF, the linked channels and scenes are turned off instantly without any ramping down (step 212).

Referring now to FIG. 13, an escape mode 230 (essentially a do-over mode) is shown. If the escape button 54 (see FIG. 4) is pressed, the system enters into the disable mode thereby exiting any linking or electricians mode (see FIG. 4), unlinking mode (see FIG. 5), scene mode (see FIG. 6), or dimming modes (see FIG. 7), and refusing any other inputs from the user interface 20 (step 236) and returning to active mode if the escape button is pressed a second time (steps 238). A second feature of the disable mode is the receiver of the RC is disabled and the RC does not act on any switch signals received thus providing a radio lockout for safety reasons if maintenance is being performed on the loads. A user may start over if the disable button is pressed a second time to return to active mode.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An apparatus for controlling a lighting environment having one or more remote switches that control one or more lighting loads, said apparatus comprising;
a linking mode connecting one or more switches to said one or more lighting loads, an unlinking mode disconnecting one or more switches from said one or more lighting loads,
one or more channels connecting one or more switches to one or more lighting loads, each said channel delivering a level of power to each said lighting load associated with said one or more channels and,
a scene mode connecting one or more channels and dimming said lighting loads to a desired dimness level in all connected channels to create a scene.

2. Said apparatus of claim 1 wherein said apparatus further comprises;
an escape mode to allow a user to escape from using any of said linking, unlinking or scene modes such that said apparatus returns to a state existing before a user entered into any of said linking, unlinking or scene modes.

3. Said apparatus of claim 1 wherein said apparatus further comprises;
One or more displays, each display relating to said a channel, said one or more displays showing whether said one or more lighting loads are linked to a switch and a representation of a level of dimness of said one or more lighting loads connected in said channel.

4. Said apparatus of claim 3 wherein said one or more display further comprises;
A representation of a number of switches associated with said one or more loads and a representation as to a type of lighting loads within said channel.

5. Said apparatus of claim 1 wherein said linking mode further comprises;
an electricians mode wherein a user may program a plurality of switches to a scene or to a channel before returning to said active mode.

6. Said apparatus of claim 1 wherein said linking mode further comprises;
a timer for returning to active mode if a user does not act in a certain amount of time.

7. Said apparatus of claim 1 wherein said channel further comprises;
an input for turning said lighting loads on or off and for connecting or disconnecting said lighting loads from said channel.

8. Said apparatus of claim 7 wherein said channel input further comprises;
a first pattern for manipulating said input to connect a remote switch from said channel.

9. Said apparatus of claim 7 wherein said channel input further comprises;
a second pattern for manipulating said channel input to connect a channel to a scene.

10. The apparatus of claim 1 wherein said apparatus further comprises:
Scene inputs connecting one or more channels to operate together or to disconnect one or more channels from each other.

11. The apparatus of claim 1 wherein said apparatus further comprises:
dimming inputs that dim or brighten a lighting load or a plurality of lighting loads or programming a load or plurality of loads in the scene or active modes.

12. The apparatus of claim 1 wherein said apparatus further comprises:
said remote switches having a first pattern of use turning lighting loads associated with said switches on to a previously set level of brightness or off and a second pattern of use dimming or brightening lighting loads associated therewith.

13. The apparatus of claim 12 wherein said remote switches further comprises:
A third pattern of use turning said lighting loads instantly on to full power.

14. The apparatus of claim 1 wherein said apparatus further comprises:
One or more said remote switches, said switches having a first pattern of use when in said linking mode for linking said switch to a lighting load.

15. The apparatus of claim 1 wherein said apparatus further comprises:
An active mode under which said remote switches are used to control one or more said lighting loads within a channel or within a scene.

16. The apparatus of claim 15 wherein said apparatus further comprises;
a lockout to prevent said active mode from functioning thereby preventing any switches from activating any loads whereby accidents may be minimized if providing maintenance to said loads attached to said system.

17. A method for controlling a lighting environment having one or more remote switches that control one or more lighting loads, said method comprising;
linking one or more said remote switches to said one or more lighting loads,
associating said one or more lighting loads with a channel for delivering power to said one or more lighting loads,
connecting one or more said channels,
dimming said lighting loads associated with said channels to a desired dimness level to create a scene.

18. The method of claim 17 for controlling a lighting environment having one or more remote switches that control one or more lighting loads, said method further comprising;
unlinking one or more switches from said one or more lighting loads or channels from a scene should a user desire to reconfigure a relationship between said switches and said lighting loads.

19. The method of claim 17 wherein said apparatus further comprises:
An active mode under which said remote switches are used to control one or more said lighting loads within a channel or within a scene.

20. The method of claim 17, said method further comprising;
Turning on said one or more loads by pressing a switch using a first pattern associated with said loads to a preset level of dimness,
Changing a dimness level of said one or more loads by pressing said switch using a second pattern until a desired level of dimness is achieved, and
Turning said one or more loads completely on or off instantaneously by pressing said lighting load using a third pattern.

21. The method of claim 17, said method further comprising;
Stopping a linking, unlinking or creating of a scene, and
Returning to a state existing before entering into any of said linking, unlinking or creating a scene.

22. The method of claim 17, said method further comprising
Displaying a number of switches associated with a load,
Displaying a type of load utilized in said channel, and
Displaying a dimness level of said channel.
